(19) United States
(12) Patent Application Publication
(10) Pub. No.: US 2007/0127057 A1
(43) Pub. Date: Jun. 7, 2007

(54) Job status tracking and notification system

(75) Inventors: Amanda K. Bridges, Winchester, KY (US); William J. G. Flowers, Lexington, KY (US); Charles E. Grieshaber, Versailles, KY (US); Chad E. McQuillen, Lexington, KY (US); Michael R. Timperman, Versailles, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/292,136

(22) Filed: Dec. 1, 2005

(51) Int. Cl. G06F 3/12

(52) U.S. Cl. 358/1.15

(57) ABSTRACT

A method for monitoring a job across a network of print devices is provided. The method includes the steps of dividing the job into at least a first child job and a second child job, communicating the first child job to a first one of the print devices, the first one of the print devices being adapted to process the first child job, and communicating the second child job to a second one of the print devices, the second one of the print devices being adapted to process the second child job, wherein the first print device generates a status report based at least upon the first child job.

The present application relates to a system for tracking job status and, more particularly, a system for tracking job status across a network of print devices.

### BACKGROUND

Multifunction peripherals (“MFP”) are devices capable of performing several related tasks including scanning, printing, duplicating, faxing and the like. A typical MFP may integrate two basic components into a single device: a document scanner and a print engine. Printing and scanning may each be carried out utilizing just one component of the device, while copying may be performed by utilizing both components.

MFPs have been adapted to communicate and share information with various servers, computers, networks and other MFPs. For example, one MFP may send a fax to another MFP by way of a communication line (e.g., a network).

As MFPs become more advanced and are capable of handling and processing more jobs, there may be need to monitor the status of the jobs being processed by the MFPs. One solution may be to provide MFPs with graphical user interfaces such that a user may monitor the jobs being handled by a particular MFP (e.g., the number of pages completed and/or the number of pages in queue) at the user interface.

Furthermore, as described in U.S. application Ser. No. 10/764,163 (Lexmark Docket No. 2003-0667.02), the entire contents of which are incorporated herein by reference, MFPs have been adapted to e-mail a user the status of a print job. For example, an MFP handling a particular print job for a user may send an email to the user once the print job is complete (e.g., “Your print job is complete”).

However, prior art MFPs have not been adapted to monitor, track and report the status of various jobs and/or workflows across an entire network of print devices.

Accordingly, there is a need for a system for tracking job status across a network of print devices.

### SUMMARY

In one aspect, the job status tracking and notification system provides a method for monitoring a job across a network of print devices is provided. The method includes the steps of dividing the job into at least a first child job and a second child job, communicating the first child job to a first one of the print devices, the first one of the print devices being adapted to process the first child job, and communicating the second child job to a second one of the print devices, the second one of the print devices being adapted to process the second child job, wherein the first print device generates a status report based at least upon the first child job.

In another aspect, the job status tracking and notification system provides a system for monitoring a job. The system includes a first print device and a second print device, the second print device being in communication with the first print device, wherein the first print device is adapted to send a child job to the second print device and the second print device is adapted to send an affirmative status report to the first device based upon the child job.

Other aspects of the job status tracking and notification system will become apparent from the following description, the accompanying drawings and the appended claims.

### BRIEF DESCRIPTION OF THE DRAWINGS

FIG. 1 is a block diagram of a first aspect of the job status tracking and notification system; and

FIG. 2 is a flow diagram of a second aspect of the job status tracking and notification system.

### DETAILED DESCRIPTION

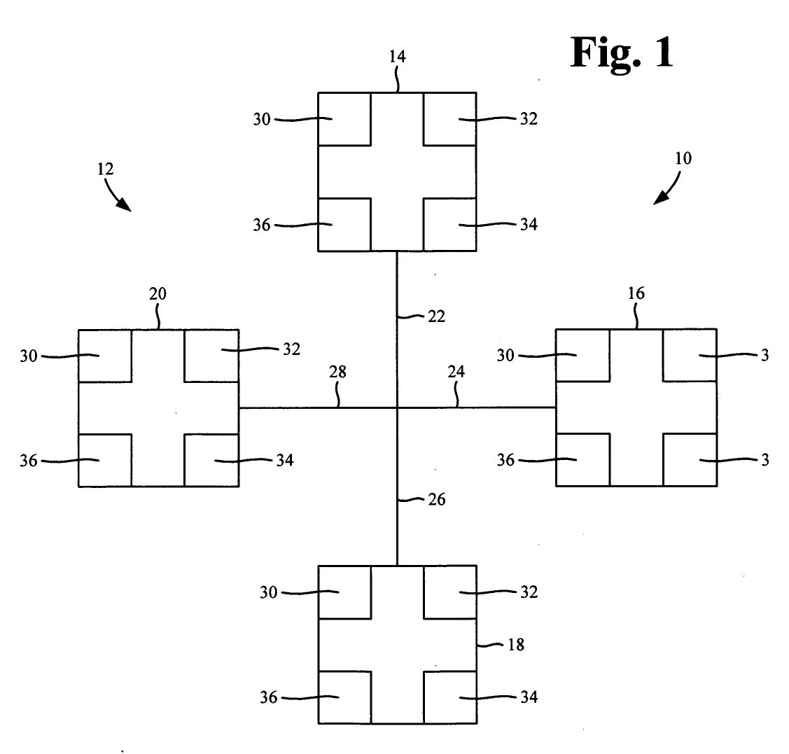

A first aspect of the job status tracking and notification system, generally designated 10, is illustrated in FIG. 1 and includes a network 12 of print devices 14, 16, 18, 20. Other devices on the network may include computers which are not shown in FIG. 1. The network 12 may include two or more print devices (there are four in FIG. 1), wherein at least two of the devices 14, 16, 18, 20 in the network 12 are in communication with each other via communication lines 22, 24, 26, 28.

Communication lines 22, 24, 26, 28 may be hard-wired communication lines or network lines (e.g., wire or cable) or, alternatively, communication lines 22, 24, 26, 28 may be a wireless means of communication (e.g., radio frequency, Wi-Fi or the like). In one aspect, communication lines 22, 24, 26, 28 may be any means for communicating data between the devices 14, 16, 18, 20 in the network 12.

The print devices 14, 16, 18, 20 in the network 12 may be any type of print devices capable of sending and/or receiving data and/or commands. In one aspect, at least one print device 14, 16, 18, 20 in the network 12 may be a MFP. In another aspect, as illustrated in FIG. 1, each device 14, 16, 18, 20 in the network 12 may be a MFP and may have a print engine 30, a scanner 32, a fax subsystem 34 and/or a user interface 36 (e.g., a graphical user interface) or any combination of these elements. At this point, it should be understood that one print device in the network 12 may be a standard inkjet printer while another print device in the network may be a MFP having printing, scanning and faxing capabilities.

According to one aspect of the job status tracking and notification system, a user may initiate a job (i.e., the parent job) or workflow at one device 14, 16, 18, 20 in the network 12. A job may be any activity that a device is capable of performing. For example, a job may be a print job, a scan job, a copy job, a fax job, sending a status report, sending an error report or the like. Once the parent job is initiated at one device in the network 12, that device may then send a child job to another device in the network 12.

According to another aspect of the job status tracking and notification system, each workflow or job may have metadata associated therewith. The metadata may include information about the user (e.g., the user's email address), information about the device that initiated the workflow (e.g., destination information) or information about the job, workflow and/or child job. Thus, child jobs may be sent to other devices in the network without getting lost and the status of the child jobs may be reported to the initiating device based on the information contained in the metadata.

For example, a user may initiate a parent job (e.g., print pages 1-10) at device 14. Device 14 may then create two child jobs (e.g., print pages 1-5 and print pages 6-10) and send one child job (e.g., print pages 6-10) to device 16 and another child job (e.g., print pages 1-5) to device 18. Additional child jobs may require devices 16, 18 to send status reports back to device 14. As devices 16, 18 process the print jobs, the devices 16, 18 may send status reports back to device 14 (e.g., “Device 16 has completed printing page 6” and “Device 18 has completed printing page 1”). Thus, the user may monitor the status of the entire workflow over all the print devices in the network 12.

Thus, a job may be initiated at a first device and the first device may generate and send a child job to a second device in the network 12. The second device may process the child job and may send a status report to the first device. Furthermore, the first device may monitor the status of the child job at the second device throughout the execution of the child job.

According to one aspect of the job status tracking and notification system, the status reports may include information about the progress of the job, errors that have occurred, the name of the job, the name of the device processing a parent or child job and/or accounting information (e.g., the number of pages printed).

Unlike prior art systems that generate status reports based on inferences, the status reports generated according to the job status tracking and notification system 10 may be based on affirmative information as it becomes available at a particular device. For example, a prior art fax machine may generate a status report once it has transmitted a certain number of pages. However, such a status report is only based on an inference made by the sending machine (i.e., the sending machine did in fact send a predetermined number of pages and that the receiving machine was active and in communication with the sending machine throughout the duration of the transmission). In contrast, the job status tracking and notification system operates on affirmative information. For example, a print device according to the job status tracking and notification system may send a user a report that a fax has be received by the device and that the device printed the fax.

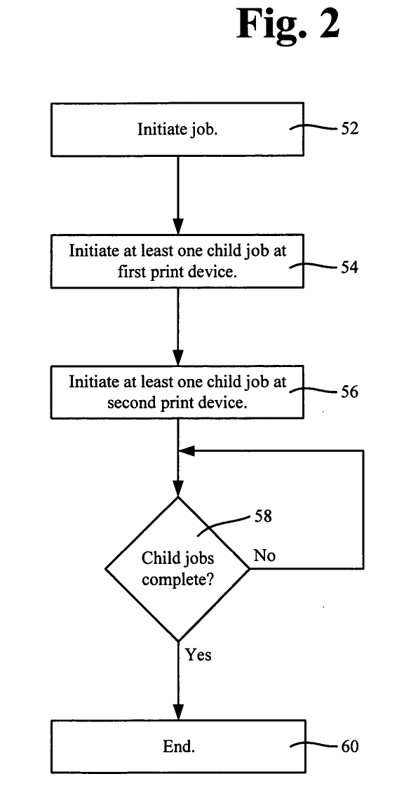

As shown in FIG. 2, the job status tracking and notification system 10 provides a process, generally designated 50, for monitoring and notifying a user of the status of a job across a network 12 of print devices 14, 16, 18, 20. The process 50 begins at box 52 when a user initiates a job (or workflow). The job may be initiated at a first print device (e.g., print device 14) in the network 12 or at a computer workstation (not shown). To initiate the job, the user may enter a job (e.g., a print job) and/or destination information (e.g., the user's email or a network identification).

As shown in boxes 54 and 56, once the job has been initiated, at least one child job is sent to at least two different devices in the network. In one aspect, one of the devices that receives a child job may be the device where the job was initiated (e.g., device 14) and the second device to receive a child job may be another one of the devices in the network (e.g., device 16). For example, when the job is a fax job, devices 14 and 16 may be selected and the device 14 may receive three child jobs (e.g., scan page, transmit data, send status report) and device 16 may receive three child jobs (e.g., receive data, print page and send status report).

As shown in box 58, once each of the child jobs have been completed and the relevant status report have been sent to the user, the process 50 comes to an end, as shown in box 60. Expanding on the example above, once the page has been scanned and transmitted by device 14 and received and printed by device 16 and the devices 14, 16 send status reports to the user, the process 50 is complete.

In another aspect, the system 10 may be applied to a prescription workflow in a hospital setting. For example, a nurse may scan a prescription having a barcode at a first MFP, thereby initiating a workflow (see FIG. 2, box 52). The first MFP may then fax the prescription to a second MFP in a pharmacy (i.e., the first child job of the first MFP, see box 54). The second MFP may send a report to the first MFP indicating that it received the prescription (i.e., the first child job of the second MFP, see box 56). The system 10 may continue to monitor the second MFP to determine whether the second MFP actually printed the fax and, alternatively, if the fax is not printed in a preset amount of time, an alarm may be triggered.

The second (pharmacy) MFP may generate and/or print the prescription bottle label, authenticate the prescription and/or archive the information in a database (i.e., perform various child jobs). The nurse may receive the filled prescription, scan the patient's bar code and the prescription bar code at the first MFP to compare to the information and, if everything matches, the workflow may closed and the nurse may administer the medicine to the patient.

Although the job status tracking and notification system is shown and described with respect to certain embodiments, it is obvious that modifications will occur to those skilled in the art upon reading the specification. The job status tracking and notification system includes all such modifications and is limited only by the scope of the claims.

What is claimed is:

1. A method for monitoring a job across a network of print devices comprising the steps of:
dividing said job into at least a first child job and a second child job;
communicating said first child job to a first one of said print devices, said first one of said print devices being adapted to process said first child job; and
communicating said second child job to a second one of said print devices, said second one of said print devices being adapted to process said second child job,
wherein said first print device generates a status report based at least upon said first child job.

2. The method of claim 1 wherein said job selected from the group consisting of a print job, a scan job, a copy job and a fax job.

3. The method of claim 1 wherein said first one of said print devices is a MFP.

4. The method of claim 3 wherein said second one of said print devices is a MFP.

5. The method of claim 1 wherein said network is a wireless network and said communicating steps include the step of wirelessly communicating.

6. The method of claim 1 wherein said network is a hard-wired network and said communicating steps include the step of sending signals over said hard-wired network.

7. The method of claim 1 wherein part of said second print device generates a status report based at least upon said second child job.

8. The method of claim 1 wherein said status report includes at least one of progress information about said job, error information about said job, a name of said job and accounting information.

9. A system for monitoring a job comprising:
a first print device; and
a second print device, said second print device being in communication with said first print device,
wherein said first print device is adapted to send a child job to said second print device and said second print device is adapted to send an affirmative status report to said first device based upon said child job.

10. The system of claim 9 wherein said child job selected from the group consisting of a print job, a scan job, a copy job and a fax job.

11. The system of claim 9 wherein said first print devices is a MFP.

12. The system of claim 11 wherein said second print devices is a MFP.

13. The system of claim 9 wherein said first print device is in wireless communication with said second print device.

14. The system of claim 9 wherein said first print device is in hard-wired communication with said second print device.

15. The system of claim 9 wherein said affirmative status report includes at least one of progress information about said child job, error information about said child job, a name of said child job and accounting information.
